(19) United States
(12) Patent Application Publication
(10) Pub. No.: US 2017/0205862 A1
(43) Pub. Date: Jul. 20, 2017

(54) LOW-POWER USB HOST SUPPORTING A HIGH-POWER USB PERIPHERAL DEVICE AND METHODS THEREOF

(71) Applicant: ASCENSIA DIABETES CARE HOLDINGS AG, Basel (CH)

(72) Inventors: Igor Y. Gofman, Croton-on-Hudson, NY (US); Christopher A. Dionisio, Millington, NJ (US)

(21) Appl. No.: 15/326,356

(22) PCT Filed: Jul. 8, 2015
(86) PCT No.: PCT/US15/39534

§ 371 Date: Jan. 13, 2017

Related U.S. Application Data
(60) Provisional application No. 62/025,281, filed on Jul. 16, 2014.

(51) Int. Cl. G06F 1/26; G06F 9/44; G06F 1/32; G06F 13/42; G06F 13/40

(52) U.S. Cl. CPC G06F 1/266; G06F 13/4282; G06F 13/4068; G06F 1/3296; G06F 9/4411

(57) ABSTRACT

A low-power USB (Universal Serial Bus) host device can be configured to establish communication with a high-power USB peripheral device. The low-power USB host device can be configured to continue an enumeration process with the high-power USB peripheral device regardless of whether the USB host device can meet a maximum power parameter of the high power USB peripheral device. In response to completing the enumeration process, the low-power USB host device can be configured to provide a lower than specified voltage to the high-power USB peripheral device, wherein the reduced voltage is sufficient to power communication between the low-power USB host device and the high-power USB peripheral device. Methods of establishing communication with a USB peripheral device are also provided, as are other aspects.

### RELATED APPLICATION

The present application claims priority to U.S. Provisional Application No. 62/025,281 filed Jul. 16, 2014 and titled “LOW-POWER USB HOST SUPPORTING A HIGH-POWER USB PERIPHERAL DEVICE AND METHODS THEREOF” which is incorporated herein by reference in its entirety for all purposes.

### FIELD

The invention relates generally to electronic USB (Universal Serial Bus) devices and, more particularly, to low-power USB hosts configured to support high-power USB peripheral devices.

### BACKGROUND

Many battery-powered handheld devices such as, e.g., blood glucose meters, are currently in use. A large number of these devices are configured to communicate with a computer or similar device via a USB connection. These USB devices, which may be referred to as USB “peripheral” devices, are typically powered by a high-power rechargeable battery pack. Also currently in use are many smart devices such as, e.g., the iPhone by Apple Inc. and various Android-based devices. Smart devices are typically configured to communicate with other devices via Bluetooth® or BLE (Bluetooth Low Energy) communication protocols. Smart devices, however, typically are not configured to function as a USB host device. Thus, large numbers of legacy battery-powered handheld peripheral devices having only a USB connector cannot communicate directly with smart devices. While USB-to-BLE adapters are known, such USB-to-BLE adapters typically require a battery larger than the battery used in the USB peripheral device in order to provide the peripheral device with the required power for communication and battery charging. Such USB-to-BLE adapters, therefore, tend to be large and expensive. Accordingly, a need exists to provide small, low-cost USB-to-BLE adapters configured to support existing USB peripheral devices.

### SUMMARY

According to one aspect, a USB (Universal Serial Bus) host device is provided. The USB host device comprises an output voltage USB connector terminal, a voltage booster having an output coupled to the output voltage USB connector terminal, and a host controller configured to perform an enumeration process with a USB peripheral device connected to the USB host device, the host controller coupled to the voltage booster, wherein the host controller is configured to cause the voltage booster to reduce a voltage at the output voltage USB connector terminal in response to completion of the enumeration process.

According to another aspect, a system is provided. The system comprises a USB (Universal Serial Bus) peripheral device and a USB host device. The USB peripheral device comprises a first USB connector, a battery charger, and a microcontroller configured to receive power via the first USB connector or a rechargeable battery. The USB host device comprises a second USB connector connected to the first USB connector, a voltage booster having an output coupled to the second USB connector, and a host controller configured to perform an enumeration process with the USB peripheral device, the host controller coupled to the voltage booster, wherein the host controller is configured to cause the voltage booster to provide a first voltage at the output of the voltage booster during the enumeration process and to provide a second voltage less than the first voltage at the output of the voltage booster in response to completion of the enumeration process.

According to a further aspect, a method of establishing communication with a USB (Universal Serial Bus) peripheral device is provided. The method comprises configuring a USB host device to continue an enumeration process with a USB peripheral device connected thereto regardless of whether the USB host device can meet a maximum power parameter of the USB peripheral device, and configuring the USB host device to reduce a voltage provided to the USB peripheral device in response to completing the enumeration process, wherein the reduced voltage is sufficient to power communication between the USB host device and the USB peripheral device.

Still other aspects, features, and advantages of the invention may be readily apparent from the following detailed description wherein a number of example embodiments and implementations are described and illustrated, including the best mode contemplated for carrying out the invention. The invention may also include other and different embodiments, and its several details may be modified in various respects, all without departing from the scope of the invention. Accordingly, the drawings and descriptions are to be regarded as illustrative in nature, and not as restrictive. The invention covers all modifications, equivalents, and alternatives of the aspects disclosed herein.

### BRIEF DESCRIPTION OF DRAWINGS

Persons skilled in the art will understand that the drawings, described below, are for illustrative purposes only. The drawings are not necessarily drawn to scale and are not intended to limit the scope of this disclosure in any way.

FIG. 1 illustrates a simplified block diagram of a system including a USB (Universal Serial Bus) peripheral device coupled to a USB host device according to the prior art.

FIGS. 2A and 2B illustrate graphs of voltage and current, respectively, versus time provided to a USB peripheral device by a USB host device according to the prior art.

FIG. 3 illustrates a simplified block diagram of a USB host device according to the prior art.

FIG. 4 illustrates a simplified block diagram of a low-power USB host device according to embodiments.

FIGS. 5A and 5B illustrate graphs of voltage and current, respectively, versus time provided to a high-power USB peripheral device by a low-power USB host device according to embodiments.

FIG. 6 illustrates a simplified block diagram of a voltage booster of a low-power USB host device according to embodiments.

FIG. 7 illustrates a flowchart of a method of establishing communication with a USB peripheral device according to embodiments.

FIG. 8 illustrates a simplified block diagram of a system including a USB peripheral device, a USB-to-smart device adapter, and a smart device according to embodiments.

### DESCRIPTION

Reference will now be made in detail to the example embodiments of this disclosure, which are illustrated in the accompanying drawings. Wherever possible, the same reference numbers will be used throughout the drawings to refer to the same or like parts.

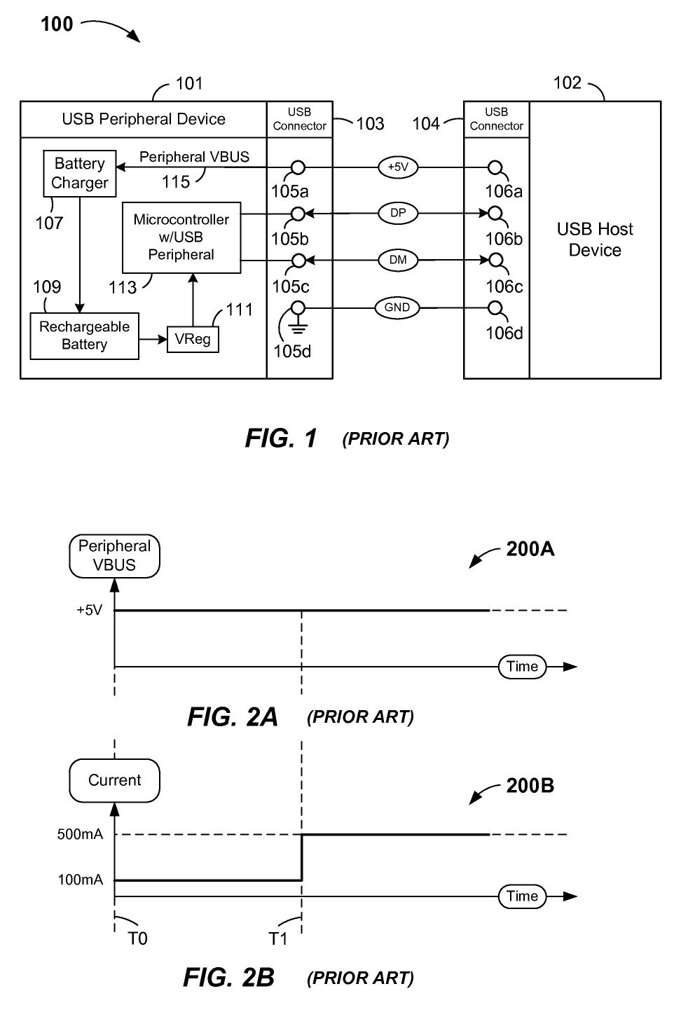

In one aspect, a low-power USB (Universal Serial Bus) host device can be configured to control voltage provided to a USB peripheral device, which can be, e.g., a blood glucose meter, powered by a rechargeable battery. Controlling the voltage can allow the low-power USB host to manipulate the charging current provided by the low-power USB host to the rechargeable battery of the USB peripheral device. For example, the charging current can be significantly reduced or reduced to zero, while the low-power USB host and the USB peripheral device communicate. While this may slow or prevent the rechargeable battery of the USB peripheral device from charging, the size of the battery of the low-power USB host can be reduced and, in some embodiments, can be smaller than the USB peripheral device's rechargeable battery. Accordingly, compact and inexpensive USB adapters, such as, e.g., a USB-to-BLE adapter, can be provided for many USB peripheral devices currently in use. Furthermore, these USB peripheral devices should not need any software or hardware modification in order to be used with the low-power USB host. In other aspects, methods of establishing communication with a USB peripheral device are provided, as will be explained in greater detail below in connection with FIGS. 1-8.

FIG. 1 illustrates a system 100 that includes a USB peripheral device 101 coupled to a USB host device 102 in accordance with the prior art. USB peripheral device 101, which may be, e.g., a blood glucose meter or other biosensor meter, can include a USB connector 103. USB connector 103 can include four USB connector terminals 105a-d, wherein USB connector terminal 105a can be configured to receive power, USB connector terminals 105b and 105c can be configured to receive and/or provide differential data signals Data Plus (DP) and Data Minus (DM), and USB connector terminal 105d can be configured to receive a power return (e.g., ground). USB peripheral device 101 can also include a battery charger 107, a rechargeable battery 109, a voltage regulator 111, and a microcontroller 113. Battery charger 107 can be coupled to connector terminal 105a to receive power via a peripheral VBUS 115. Rechargeable battery 109 can be coupled to battery charger 107 and can be a high-power Li—Po (lithium polymer), Ni—Cd (nickel-cadmium), or Ni—Mh (nickel-metal hydride) battery or battery pack. Voltage regulator 111 can be an LDO (low dropout) voltage regulator and can be coupled to rechargeable battery 109. And microcontroller 113 can be coupled to voltage regulator 111 to receive power. Microcontroller 113 can also be coupled to connector terminals 105b and 105c to receive and transmit data and can include USB peripheral control functionality. For example, in cases where USB peripheral device 101 can be a blood glucose meter, microcontroller 113 can be configured to perform various calculations and functions related to measuring, storing, displaying, and/or communicating a concentration of an analyte in a fluid sample, such as, e.g., blood. USB peripheral device 101 may conform to the USB 2.0 specification.

USB host device 102 can include a USB connector 104, which can include four USB connector terminals 106a-d. USB connector terminal 106a can be configured to provide power, USB connector terminals 106b and 106c can be configured to provide and/or receive differential data signals Data Plus (DP) and Data Minus (DM), and USB connector terminal 106d can be configured to provide a power return (e.g., ground). USB host device 102 may conform to the USB 2.0 specification.

Upon connection of USB host device 102 to USB peripheral device 101 via USB connectors 103 and 104, a positive voltage ranging from about 4.75 volts to about 5.25 volts (i.e., about 5 volts in accordance with, e.g., the USB 2.0 specification) may be provided by USB host device 102 to peripheral VBUS 115 via USB connector terminal 105a of USB peripheral device 101. In response to receiving an appropriate voltage on peripheral VBUS 115, an “enumeration” process can begin. An enumeration process can include detecting, identifying, and establishing communication between a USB peripheral device and a USB host. According to the USB 2.0 specification, the enumeration process should not require more than 100 mA of current drawn from USB host device 102. Upon beginning the enumeration process, USB host device 102 typically requests and USB peripheral device 101 typically sends configuration information to USB host device 102. The configuration information can include a maximum power parameter for USB peripheral device 101, which is typically specified in terms of current (i.e., power=current×the specified peripheral VBUS voltage).

Generally, two different USB power parameters are known for USB 2.0 peripheral devices: 100 mA operation and 500 mA operation. Most, if not all, USB host devices should be able to provide 100 mA to a USB peripheral device. However, only some USB host devices (e.g., high-power USB host devices) are able to provide 500 mA to a high-power USB peripheral device. Thus, if a USB peripheral device has a maximum power parameter of 500 mA, and the USB host device is not able to provide 500 mA, the USB host device will typically stop the enumeration process. By stopping the enumeration process, communication between the USB peripheral device and the USB host device cannot be established.

Assuming that, e.g., USB peripheral device 101 has a maximum power parameter of 500 mA, and that USB host device 102 can meet that power parameter, USB host device 102 typically will implicitly acknowledge being able to meet that power parameter by continuing with the enumeration process. Upon completion of the enumeration process, communication between USB peripheral device 101 and USB host device 102 should be established.

FIGS. 2A and 2B illustrate waveforms 200A and 200B of voltage and current, respectively, versus time provided to USB peripheral device 101 by USB host device 102 in accordance with the prior art. At time T0, USB peripheral device 101 can be connected to USB host device 102 via USB connectors 103 and 104, respectively. In response, as shown in FIG. 2A, USB peripheral device 101 can receive about +5 volts on peripheral VBUS 115 from USB host device 102. This typically causes the enumeration process to begin. As shown in FIG. 2B, USB peripheral device 101 can draw a maximum of about 100 mA from USB host device 102 via peripheral VBUS 115. The enumeration process can occur from time T0 to time T1. In response to the enumeration process completing at time T1, the voltage on peripheral VBUS 115 typically remains at about +5 volts as shown in FIG. 2A, while the current on peripheral VBUS 115 can increase at time T1 to a maximum of about 500 mA as shown in FIG. 2B. The 500 mA current can include a maximum current for charging rechargeable battery 109 and a current to drive microcontroller 113 and other circuitry (not shown) in USB peripheral device 101. At time T1+, communication between USB peripheral device 101 and USB host device 102 can occur, along with a charging of rechargeable battery 109 (as needed) until USB peripheral device 101 is disconnected from USB host device 102.

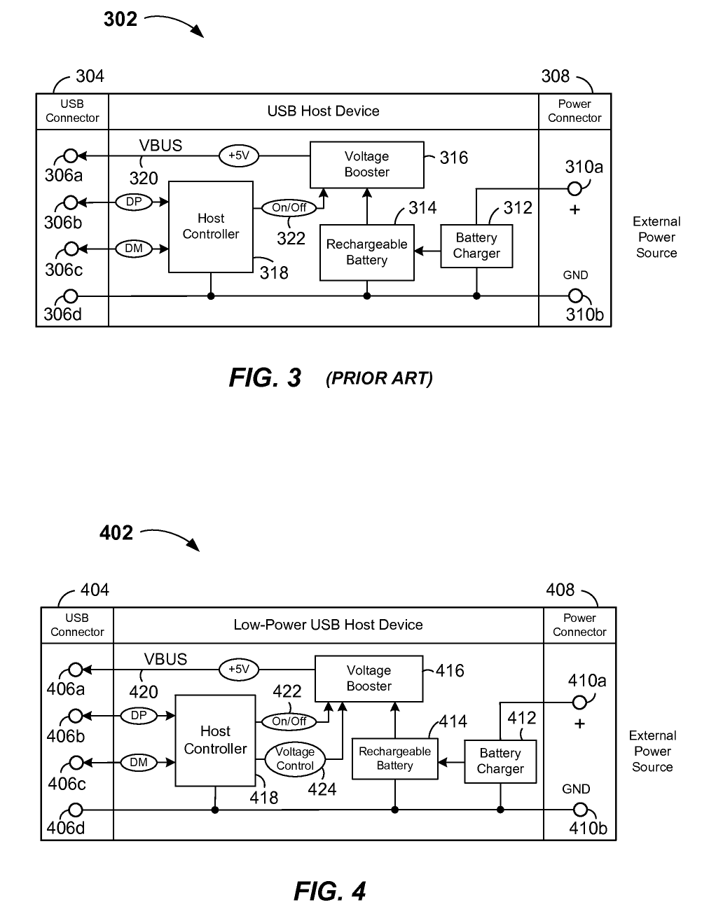

FIG. 3 illustrates a typical USB host device 302 that can be connected to USB peripheral device 101 in accordance with the prior art. USB host device 302 can include a USB connector 304, which can include four USB connector terminals 306a-d. USB connector terminal 306a can be configured to provide power, USB connector terminals 306b and 306c can be configured to provide and/or receive differential data signals Data Plus (DP) and Data Minus (DM), and USB connector terminal 306d can be configured to provide a power return (e.g., ground). USB host device 302 can also include a power connector 308, which can include a power terminal 310a and a ground terminal 310b configured to be coupled to an external power source.

USB host device 302 can further include a battery charger 312, a rechargeable battery 314, a voltage booster 316, and a host controller 318. Battery charger 312 can be coupled to power connector 308. Rechargeable battery 314 can be coupled to battery charger 312 and can be, e.g., a Li—Po battery. Voltage booster 316 can be coupled to rechargeable battery 314 and to USB connector terminal 306a via a VBUS 320. Rechargeable battery 314 can typically provide about 3.7 volts to voltage booster 316. Voltage booster 316, in turn, converts (or “boosts”) the 3.7 volts to about 5 volts in order to provide at USB connector terminal 306a the specified voltage for a peripheral VBUS, such as peripheral VBUS 115. Host controller 318 can be coupled to USB connector terminals 306b and 306c to receive and transmit data via differential data signals Data Plus (DP) and Data Minus (DM).

Host controller 318 is typically configured to have only ON/OFF control of voltage booster 316. That is, in response to a USB peripheral device, such as, e.g., USB peripheral device 101, being connected to USB host device 302, host controller 318 can provide an enable (i.e., an ON) signal via an ON/OFF signal line 322 to turn on voltage booster 316. In response, voltage booster 316 can provide a steady +5 volts on VBUS 320. In response to a USB peripheral device being disconnected from USB host device 302, host controller 318 can provide a disable (i.e., an OFF) signal via ON/OFF signal line 322 to voltage booster 316 to turn off voltage booster 316, wherein no voltage is provided on VBUS 320.

In cases where USB peripheral device 101 is a high-power USB peripheral device having a 500 mA maximum power parameter, rechargeable battery 109 may typically have, e.g., a battery capacity of 300 mAh. Such a rechargeable battery 109 can typically be charged with a maximum charging current (known as the “1 C” charge rate) of 300 mA. The additional 200 mA of the 500 mA maximum power parameter can represent additional maximum current that may be required to power electronic circuitry (including, e.g., microcontroller 113) of USB peripheral device 101. In order to provide 500 mA to USB peripheral device 101, rechargeable battery 314 of USB host device 302 should accordingly have a minimum capacity of at least 500 mAh. Thus, rechargeable battery 314 of USB host device 302 is typically larger than rechargeable battery 109 of USB peripheral device 101. In some cases, rechargeable battery 314 can be about 1.7 times larger than rechargeable battery 109. Consequently, USB host device 302 can be large and expensive.

FIG. 4 illustrates a low-power USB host device 402 in accordance with one or more embodiments. In some embodiments, low-power USB host device 402 can be compact and inexpensive in comparison to, e.g., USB host device 302. Low-power USB host device 402 can be configured to support communication between low-power USB host device 402 and USB peripheral device 101, including a high-power version of USB peripheral device 101 having, e.g., a 500 mA power parameter. In some embodiments, low-power USB host device 402 can be configured to support peripheral devices conforming to the USB 2.0 specification. In other embodiments, low-power USB host device 402 can be alternatively configured to support peripheral devices conforming to other suitable USB specifications. Low-power USB host device 402 can also be configured in some embodiments to work with power parameters other than the 100 mA and 500 mA power parameters described herein.

Low-power USB host device 402 can include a USB connector 404, which can include four USB connector terminals 406a-d. USB connector terminal 406a, which can be an output voltage USB connector terminal, can be configured to provide power, USB connector terminals 406b and 406c can be configured to provide and/or receive differential data signals Data Plus (DP) and Data Minus (DM), and USB connector terminal 406d can be configured to provide a power return (e.g., ground). Low-power USB host device 402 can also include a power connector 408, which can include a power terminal 410a and a ground terminal 410b configured to be coupled to an external power source.

Low-power USB host device 402 can further include a battery charger 412, a rechargeable battery 414, a voltage booster 416, and a host controller 418. Battery charger 412 can be coupled to power connector 408. Rechargeable battery 414 can be coupled to battery charger 412 and can be, e.g., a Li—Po battery. Other suitable types of batteries may be used. Voltage booster 416 can be coupled to rechargeable battery 414 and to USB connector terminal 406a via a VBUS 420. In some embodiments, rechargeable battery 414 can provide about 3.7 volts to voltage booster 416. Voltage booster 416, in turn, can convert (or “boost”) the 3.7 volts to, in some embodiments, about +5 volts during an enumeration process in order to provide at USB connector terminal 406a the specified voltage for a peripheral VBUS, such as peripheral VBUS 115. Host controller 418 can be coupled to USB connector terminals 406b and 406c to receive and transmit data via differential data signals Data Plus (DP) and Data Minus (DM). Host controller 418 can be any suitable microprocessor, microcontroller, logic circuit, programmable logic device, or the like.

Host controller 418 can be configured to provide an enable/disable signal to voltage booster 416 via an ON/OFF signal line 422. That is, in response to a USB peripheral device, such as USB peripheral device 101, being connected to low-power USB host device 402, host controller 418 can provide an enable (i.e., an ON) signal via ON/OFF signal line 422 to turn on voltage booster 416. In response, voltage booster 416 can be configured to initially provide, e.g., about +5 volts on VBUS 420. In response to a USB peripheral device being disconnected from low-power USB host device 402, host controller 418 can provide a disable (i.e., an OFF) signal via ON/OFF signal line 422 to voltage booster 416 to turn off voltage booster 416, wherein no voltage is provided on VBUS 420.

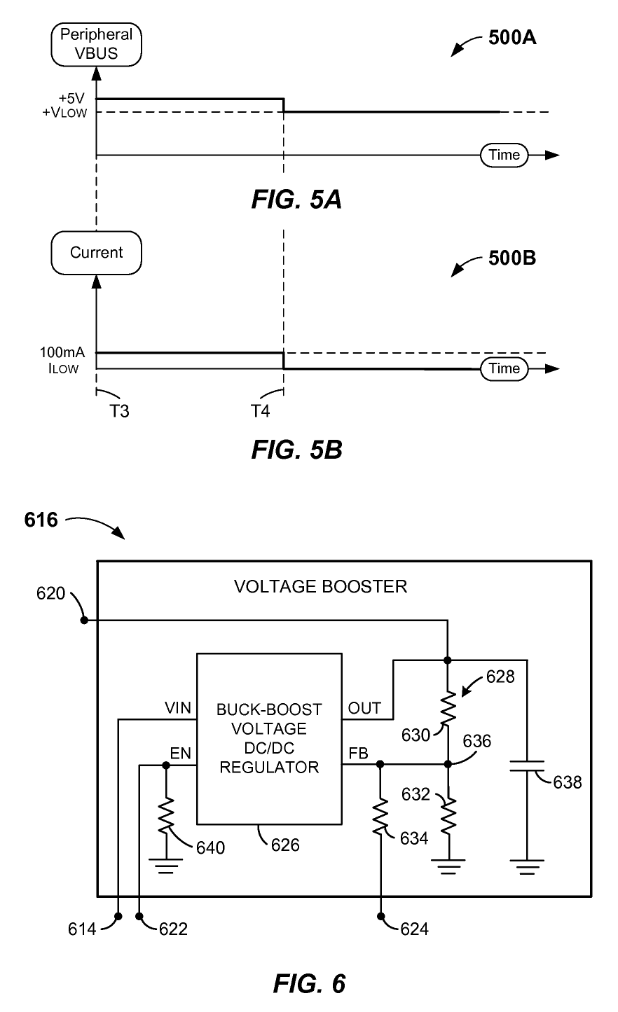

To reduce the size of rechargeable battery 414 in comparison to rechargeable battery 314 of USB host device 302, and accordingly reduce the size and cost of low-power USB host device 402 in comparison to USB host device 302, host controller 418 can also be configured to provide first and second voltage control signals to voltage booster 416. The voltage control signals can be provided to voltage booster 416 via a voltage control line 424. As described in more detail below in connection with FIGS. 5A, 5B, and 6, host controller 418 can be configured to issue a first voltage control signal in response to the start of an enumeration process and a second voltage control signal in response to completion of the enumeration process. The second voltage control signal can cause voltage booster 416 to reduce the voltage on VBUS 420, wherein the reduced voltage is sufficient to power communication between low-power USB host device 402 and a USB peripheral device such as, e.g., USB peripheral device 101.

FIGS. 5A and 5B illustrate waveforms 500A and 500B of voltage and current, respectively, versus time provided to a USB peripheral device, such as, e.g., USB peripheral device 101 by low-power USB host device 402 in accordance with one or more embodiments. At time T3, USB peripheral device 101, e.g., can be connected to low-power USB host device 402 via USB connectors 103 and 404, respectively. In response, host controller 418 can issue a first voltage control signal via voltage control line 424 to voltage booster 416 wherein, as shown in FIG. 5A, voltage booster 416 can provide about +5 volts to USB peripheral device 101 on peripheral VBUS 115 via USB connector terminals 105a and 406a and VBUS 420. This can cause an enumeration process to begin. As shown in FIG. 5B, USB peripheral device 101 can draw up to a maximum of about 100 mA from low-power USB host device 402 in accordance with, e.g., the USB 2.0 specification during the enumeration process, which can occur from time T3 to time T4. In response to commencing the enumeration process, low-power USB host device 402, and in particular host controller 418, can request configuration information from USB peripheral device 101. The configuration information can include a maximum power parameter that defines the maximum power, usually specified in terms of current (power=current×the specified +5 volt peripheral VBUS voltage) required by USB peripheral device 101. The maximum current specified in the maximum power parameter can include the maximum charging current for rechargeable battery 109 and the maximum current for operating the electronic circuitry (including, e.g., microcontroller 113) of USB peripheral device 101. Regardless of whether low-power USB host device 402 can meet the maximum power parameter (that is, e.g., provide the maximum requested current), low-power USB host device 402, and in particular host controller 418, can be configured to continue the enumeration process, implicitly acknowledging that the maximum power parameter can be met. In some embodiments, host controller 418 can be configured via software to continue the enumeration process regardless of whether low-power USB host device 402 can meet the maximum power parameter of USB peripheral device 101.

At time T4, the enumeration process can complete and USB communication between low-power USB host device 402 and USB peripheral device 101 can be established. Host controller 418, which can determine when the enumeration process has completed, can issue a second voltage control signal via voltage control line 424 to voltage booster 416. In response to receiving the second voltage control signal, voltage booster 416 can be configured to reduce the voltage at time T4 on VBUS 420, and consequently on peripheral VBUS 115, to VLOW as shown in FIG. 5A. VLOW can be sufficient to power communication between low-power USB host device 402 and USB peripheral device 101. In some embodiments, VLOW can range from about 4.2 volts to about 3.6 volts, depending on the particular USB peripheral device connected to low-power USB host device 402 and on the battery charger topology of the particular USB peripheral device. In alternative embodiments, VLOW can have other suitable voltage values sufficient to power USB communication between low-power USB host device 402 and a USB peripheral device. Note that battery chargers require a minimum input voltage in order to provide a specified charge current. If the input battery charger voltage is below the minimum value, the battery charger automatically reduces the charge current.

Concurrently at time T4, the current provided on peripheral VBUS 115 can be reduced to ILOW, as shown in FIG. 5B. In some embodiments, ILOW can be zero. Thus, in those embodiments, no current is provided for battery charging in USB peripheral device 101 and no power is consumed from low-power USB host device 402 during USB communication between USB peripheral device 101 and low-power USB host device 402. Accordingly, in some embodiments, low-power USB host device 402 can be configured with a small rechargeable battery 414 having a capacity ranging from, e.g., about 100 mAh to about 160 mAh. The size/capacity of rechargeable battery 414 can be based on the maximum current required by low-power USB host device 402 itself and the maximum current provided to USB peripheral device 101 during the enumeration process. USB communication can occur at time T4+ until USB peripheral device 101 is disconnected from low-power USB host device 402. In other embodiments, ILOW can be set to any suitable current value (e.g., to provide some charging current if desired). However, some current values above zero may require a larger rechargeable battery 414.

FIG. 6 illustrates a voltage booster 616 that can be used in low-power USB host device 402 in accordance with one or more embodiments. Voltage booster 616 can include an output 620, a battery power input 614, an enable input 622, a voltage control input 624, a buck-boost DC/DC voltage regulator 626, and a variable voltage divider 628. Output 620 can be coupled to an output OUT of buck-boost DC/DC voltage regulator 626 to receive an output voltage thereat and can be configured to be coupled to a VBUS such as, e.g., VBUS 420 of low-power USB host device 402. Battery power input 614 can be coupled to a VIN input of buck-boost DC/DC voltage regulator 626 and can be configured to receive battery power from and be coupled to a rechargeable battery such as, e.g., rechargeable battery 414 of low-power USB host device 402. Enable input 622 can be coupled to an enable input EN of buck-boost DC/DC voltage regulator 626 and can be configured to receive an ON/OFF signal from and be coupled to a host controller, such as, e.g., host controller 418 via ON/OFF signal line 422 of low-power USB host device 402. In some embodiments, buck-boost DC/DC voltage regulator 626 can be a TPS63020 Buck-Boost Converter by Texas Instruments Incorporated. Other suitable buck-boost DC/DC voltage regulators can be used in alternative embodiments. In some embodiments, voltage booster 616 can also include a capacitor 638 and a resistor 640. Capacitor 638 can be coupled to output 620, and resistor 640 can be coupled to enable input 622. In some embodiments, capacitor 638 can be about 22 μF and resistor 640 can be about 100 k ohms. Other suitable values can be used.

Variable voltage divider 628 can provide two different voltages at output 620. Variable voltage divider 628 can include a first resistor 630 and a second resistor 632 coupled in series, and a third resistor 634 coupled in parallel with second resistor 632. One end of first resistor 630 can be coupled to output 620 and the output OUT of buck-boost DC/DC voltage regulator 626. A node 636 between first resistor 630 and second resistor 632 can be coupled to a feedback input FB of buck-boost DC/DC voltage regulator 626. One end of third resistor 634 can also be coupled to feedback input FB and node 636, while the other end of third resistor 634 can be coupled to voltage control input 624. Voltage control input 624 can be coupled to a voltage control line, such as, e.g., voltage control line 424 of low-power USB host device 402.

The electrical state of a voltage control signal received at voltage control input 624 can determine which of two voltage values can be provided at output 620. For example, in response to a low voltage control signal received at voltage control input 624 from, e.g., host controller 418, a first voltage can be provided at output 620. A low voltage control signal can effectively connect third resistor 634 in parallel with second resistor 632. In some embodiments, a low voltage control signal can be provided from host controller 418 at the start of and during an enumeration process. In response to a high impedance voltage control signal received at voltage control input 624 from, e.g., host controller 418, a second reduced voltage (i.e., less than the first voltage) can be provided at output 620. A high-impedance voltage control signal can effectively disconnect third resistor 634 from variable voltage divider 628. This can cause voltage at the feedback input FB and node 636 to increase, thus reducing the voltage at output 620. In some embodiments, a high-impedance voltage control signal can be provided from host controller 418 in response to completion of the enumeration process, such as, e.g., at time T4 of FIGS. 5A and 5B.

The resistor values of variable voltage divider 628 can be selected to provide the two voltage values at output 620. For example, in some embodiments, to provide a first voltage of about 5 volts at output 620 in response to a low voltage control signal, and to provide a second reduced voltage of about 3.6 volts at output 620 in response to a high-impedance voltage control signal, with an input battery voltage at battery power input 614 of about 3.7 volts, first resistor 630 can be about 1.3 M ohms, second resistor 632 can be about 182 k ohms, and third resistor 634 can be about 680 k ohms. Other resistor values can be used to provide other voltages at output 620.

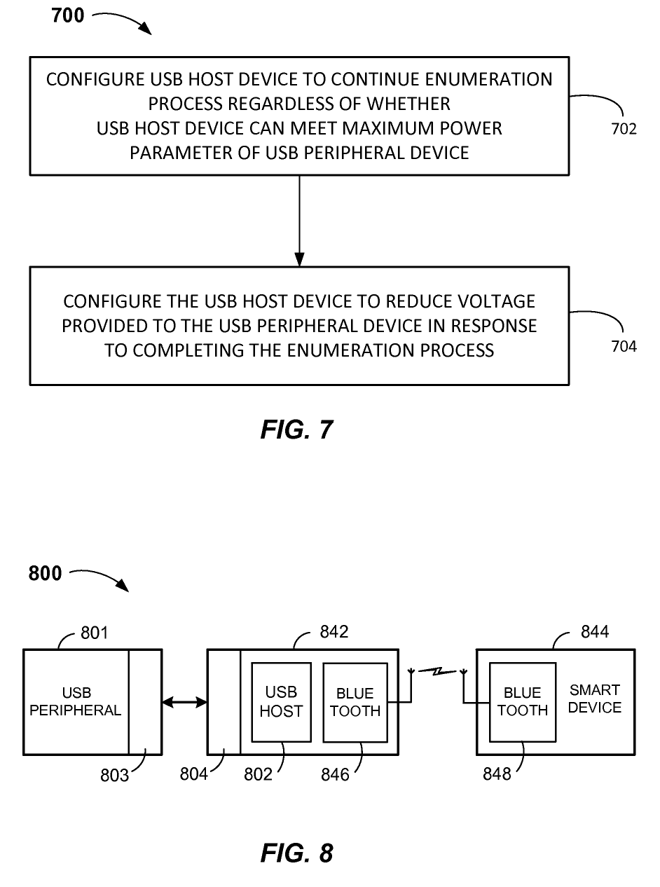

FIG. 7 illustrates a method 700 of establishing communication with a USB (Universal Serial Bus) peripheral device. In some embodiments, the USB peripheral device can be a biosensor meter such as, e.g., a blood glucose meter. At process block 702, method 700 can include configuring a USB host device to continue an enumeration process with a USB peripheral device connected thereto regardless of whether the USB host device can meet a maximum power parameter of the USB peripheral device. For example, in some embodiments, the USB peripheral device can be USB peripheral device 101, and the USB host device can be low-power USB host device 402. The maximum power parameter of the USB peripheral device may specify a maximum current of 500 mA at 5 volts. The USB host device can be configured to continue an enumeration process with the USB peripheral device even though the USB host device cannot meet the specified maximum current and/or voltage specified by the USB peripheral device. In some embodiments, the USB host device can include software executing in a host controller of the USB host device, such as, e.g., host controller 418 of low-power USB host device 402, that can allow an enumeration process to continue between the USB host device and the USB peripheral device regardless of whether the USB host device can meet a maximum power parameter of the USB peripheral device.

At process block 704, method 700 can include configuring the USB host device to reduce a voltage provided to the USB peripheral device in response to completing an enumeration process between the USB host device and the USB peripheral device, wherein the reduced voltage is sufficient to power communication between the USB host device and the USB peripheral device. For example, during an enumeration process, the USB host device, which can be, e.g., low-power USB host device 402, can be configured to provide about +5 volts to a peripheral VBUS of a USB peripheral device, such as, e.g., peripheral VBUS 115 of USB peripheral device 101. In response to completing the enumeration process, the USB host device can be configured to reduce the voltage provided to the peripheral VBUS to about +3.6 volts or other suitable lower voltage. The +3.6 volts or other suitable lower voltage can be sufficient to power communication between the USB host device and the USB peripheral device.

In some embodiments, the reduced voltage provided by the USB host device can result in the USB peripheral device operating with less than its specified maximum current. That is, the reduced voltage can cause a battery charger, such as, e.g., battery charger 107 of FIG. 1, in the USB peripheral device to reduce the amount of charging current provided to a rechargeable battery, such as, e.g., rechargeable battery 109 of FIG. 1, in the USB peripheral device. This reduced current, however, should not adversely affect the communication established between the USB host device and the USB peripheral device.

FIG. 8 illustrates a system 800 that includes a USB peripheral device 801 coupled via a USB connection to a USB-to-smart device adapter 842, which can be in wireless communication with a smart device 844 in accordance with one or more embodiments. USB peripheral device 801, which may be, e.g., a blood glucose meter or other biosensor meter, can include a USB connector 803. In some embodiments, USB peripheral device 801 and/or USB connector 803 can be similar or identical to USB peripheral device 101 and/or USB connector 103, respectively. USB-to-smart device adapter 842 can include a low-power USB host device 802 and a USB connector 804. In some embodiments, low-power USB host device 802 and/or USB connector 804 can be similar or identical to low-power USB host device 402 and/or USB connector 404, respectively. USB-to-smart device adapter 842 can also include a Bluetooth® transmitter/receiver device 846. Smart device 844, which can be a smartphone, tablet, or like device, can include a Bluetooth® transmitter/receiver device 848 configured to wirelessly communicate with Bluetooth® transmitter/receiver device 846. In alternative embodiments, other types of transmitters/receivers and/or communication protocols can be used instead of Bluetooth® transmitter/receiver device 846 and Bluetooth® transmitter/receiver device 848. Low-power USB host device 802 can have a rechargeable battery smaller than a rechargeable battery of USB peripheral device 801. Accordingly, USB-to-smart device adapter 842 can be a compact and an inexpensive device that in some embodiments can be conveniently carried with USB peripheral device 801 to provide communication capabilities between USB peripheral device 801 and smart device 844.

Note that some embodiments, or portions thereof, may be provided as a computer program product or software that may include a machine-readable medium having non-transient instructions stored thereon, which may be used to program a computer system, controller, or other electronic device to perform a process in accordance with one or more embodiments.

Persons skilled in the art should readily appreciate that the invention described herein is susceptible of broad utility and application. Many embodiments and adaptations of the invention other than those described herein, as well as many variations, modifications, and equivalent arrangements, will be apparent from, or reasonably suggested by, the invention and the foregoing description thereof, without departing from the substance or scope of the invention. For example, although described in connection with USB peripheral and USB host devices, one or more embodiments of the invention may be used with other types of battery-powered electronic devices where communication can be established between a host device and a non-host device with less than a maximum amount power specified by the non-host device. Accordingly, while the invention has been described herein in detail in relation to specific embodiments, it should be understood that this disclosure is only illustrative and presents examples of the invention and is made merely for purposes of providing a full and enabling disclosure of the invention. This disclosure is not intended to limit the invention to the particular apparatus, devices, assemblies, systems or methods disclosed, but, to the contrary, the intention is to cover all modifications, equivalents, and alternatives falling within the scope of the invention.

What is claimed is:

1. A USB (Universal Serial Bus) host device, comprising:
an output voltage USB connector terminal;
a voltage booster having an output coupled to the output voltage USB connector terminal; and
a host controller configured to perform an enumeration process with a USB peripheral device connected to the USB host device, the host controller coupled to the voltage booster; wherein:
the host controller is configured to cause the voltage booster to reduce a voltage at the output voltage USB connector terminal in response to completion of the enumeration process.

2. The USB host device of claim 1, wherein the host controller is configured to continue the enumeration process regardless of whether the USB host device can meet a maximum power parameter of the USB peripheral device.

3. The USB host device of claim 2, wherein the host controller is configured via software to continue the enumeration process regardless of whether the USB host device can meet a maximum power parameter of the USB peripheral device.

4. The USB host device of claim 1, wherein the voltage booster comprises a variable voltage divider coupled to the host controller, wherein the variable voltage divider is configured to reduce the voltage at the output of the voltage booster in response to completion of the enumeration process.

5. The USB host device of claim 1, wherein the voltage booster comprises a variable voltage divider that comprises a first resistor coupled in series with a second resistor, and a third resistor coupled in parallel with the second resistor.

6. The USB host device of claim 5, wherein the voltage booster comprises a voltage control input coupled to the third resistor, the voltage control input configured to receive a first voltage control signal from the host controller that effectively connects the third resistor to the variable voltage divider, and configured to receive a second voltage control signal from the host controller that effectively disconnects the third resistor from the variable voltage divider.

7. The USB host device of claim 6, wherein the first voltage control signal from the host controller is a low voltage control signal and the second voltage control signal from the host controller is a high impedance voltage control signal.

8. The USB host device of claim 1, wherein the voltage booster is configured to provide no current at the output of the voltage booster in response to completion of the enumeration process.

9. The USB host device of claim 1, wherein the host controller is configured to cause the voltage booster to reduce a voltage at the output voltage USB connector terminal in response to completion of the enumeration process from about 5 volts to about 3.6 volts.

10. A system, comprising:
a USB (Universal Serial Bus) peripheral device comprising:
a first USB connector,
a battery charger, and
a microcontroller configured to receive power via the first USB connector or a rechargeable battery; and
a USB host device comprising:
a second USB connector connected to the first USB connector,
a voltage booster having an output coupled to the second USB connector, and
a host controller configured to perform an enumeration process with the USB peripheral device, the host controller coupled to the voltage booster; wherein:
the host controller is configured to cause the voltage booster to provide a first voltage at the output of the voltage booster during the enumeration process and to provide a second voltage less than the first voltage at the output of the voltage booster in response to completion of the enumeration process.

11. The system of claim 10, wherein the voltage booster comprises a variable voltage divider that comprises a first resistor coupled in series with a second resistor, and a third resistor coupled in parallel with the second resistor.

12. The system of claim 11, wherein the voltage booster comprises a voltage control input coupled to the third resistor, wherein the voltage control input is configured to receive a first voltage control signal from the host controller that effectively connects the third resistor to the variable voltage divider and is configured to receive a second voltage control signal from the host controller that effectively disconnects the third resistor from the variable voltage divider.

13. The system of claim 10, wherein the USB peripheral device comprises a blood glucose meter and the microcontroller is configured to determine a property of an analyte in a fluid.

14. A method of establishing communication with a USB (Universal Serial Bus) peripheral device, the method comprising:
configuring a USB host device to continue an enumeration process with a USB peripheral device connected thereto regardless of whether the USB host device can meet a maximum power parameter of the USB peripheral device; and
configuring the USB host device to reduce a voltage provided to the USB peripheral device in response to completing the enumeration process, wherein the reduced voltage is sufficient to power communication between the USB host device and the USB peripheral device.

15. The method of claim 14 further comprising configuring the USB host device to provide a first voltage and a first current to the USB peripheral device during the enumeration process.

16. The method of claim 14 wherein the configuring the USB host device to reduce a voltage provided to the USB peripheral device comprises providing no current for charging a rechargeable battery of the USB peripheral device.

17. The method of claim 14, further comprising configuring the USB host device to include a voltage booster comprising a variable voltage divider configured to reduce the voltage provided to the USB peripheral device in response to completing the enumeration process.

18. The method of claim 14, further comprising configuring the USB host device to commence the enumeration process in response to the USB peripheral device being connected to the USB host device.

19. The method of claim 18, further comprising configuring the USB host device to request configuration information from the USB peripheral device in response to commencing the enumeration process, the configuration information including the maximum power parameter.

20. The method of claim 14, further comprising configuring a host controller of the USB host device to issue a first voltage control signal in response to commencing the enumeration process and to issue a second voltage control signal in response to completing the enumeration process.
